(19) United States
(12) Patent Application Publication
(10) Pub. No.: US 2004/0145891 A1
(43) Pub. Date: Jul. 29, 2004

(54) Lightning device

(75) Inventors: Helmut M. Heine, Herrsching (DE); Norbert Merkt, Breitbrunn (DE)

Correspondence Address: ROTHWELL, FIGG, ERNST & MANBECK, P.C., 1425 K STREET, N.W., SUITE 800, WASHINGTON, DC, 20005, US

(73) Assignee: Heine Optotechnik GmbH & Co. KG, Herrsching (DE)

(21) Appl. No.: 10/740,842

(22) Filed: Dec. 22, 2003

(30) Foreign Application Priority Data
Dec. 27, 2002 (DE) 202 19 987.8

(51) Int. Cl. F21L 4/00; F21S 4/00

(52) U.S. Cl. 362/186; 362/335; 362/800

(57) ABSTRACT

A lightning device includes a component in which a light-emitting diode and adapter electronics are integrated. The component corresponds mechanically and : electrically to an electric light bulb, the adapter electronics converting the voltage usually delivered to a conventional electric light bulb into a voltage required by the light-emitting diode.

### BACKGROUND OF THE INVENTION

1. Field of the Invention

The invention is in the field of lightning devices.

2. Description of the Background Art

Miniature electric light bulbs are used in many appliances, including in hand-held medical diagnostic instruments. Their purpose is to illuminate the field to be viewed, for example body parts and body cavities, as brightly as possible.

Because of the high demands placed on the intensity of the light, miniature electric light bulbs in most cases have a working life of just a few hours. They are also expensive and therefore represent an important cost factor. The high current consumption entails high costs for current supply, for example using chargers for chargeable batteries and using power packs, or high running costs are involved in operating with dry batteries.

With the availability of light-emitting diodes, in particular diodes emitting white light, there are more and more applications in which electric light bulbs are being replaced by light-emitting diodes. These consume much less current and have a much longer working life than electric light bulbs. However, a disadvantage is that, in order to achieve an illumination equivalent to the illumination obtained using an electric light bulb, a plurality of light-emitting diodes is required (see DE 100 31 685 A1), and elaborate optical devices are in most cases needed in order to focus the light of the individual LEDs into a homogeneous luminous field. Another disadvantage is that light-emitting diodes are available only for certain operating voltages and, for this reason, electronic adaptation to conventional current supplies is necessary unless altogether different current supplies are required.

### SUMMARY OF THE INVENTION

The invention relates to lightening device comprising a light-emitting diode, in particular, in particular for use in medical diagnostic instruments.

The object of the invention is therefore to make available lightning device comprising a light-emitting diode which has a similar mechanical construction and a similar electrical function to conventional light bulbs.

According to the invention, this object is achieved by a lightning device in which a light-emitting diode (LED) and adapter electronics are integrated in such a way that the light-emitting diode can be operated using a standard type of power supply. The outer geometry of the lightning device comprising the light-emitting diode and adapter electronics is so configured that it fits into customary sockets.

In this way it is possible to use existing devices with conventional current supplies and to utilize the advantages of the light-emitting diodes without limitation.

In a preferred embodiment, a focussing optical system, in the simplest case a positive lens, is integrated into the transparent part of the housing of the lighting device. By this means it is possible to distribute the light more uniformly across the field to be illuminated, so that it is not necessary to use a plurality of light-emitting diodes and, instead, a single light-emitting diode is sufficient to illuminate the field. In this way light-emitting diodes can also be used in devices, in particular medical diagnostic instruments, in which there is only one seat or socket for the lighting means.

### BRIEF DESCRIPTION OF THE DRAWINGS

Embodiments of the invention will now be described with reference to the attached drawings in which:

FIG. 1 illustrates a known miniature electric light bulb having a screwable lamp socket and a condenser lens,

FIG. 2 illustrates a known miniature electric light bulb having a pluggable lamp socket without optical system,

FIG. 3 a miniature electric lighting device in accordance with the present invention having a screwable lamp socket and a condenser lens,

FIG. 4 a miniature electric lighting device in accordance with the present invention having a pluggable lamp socket without optical system.

### DETAILED DESCRIPTION OF THE INVENTION

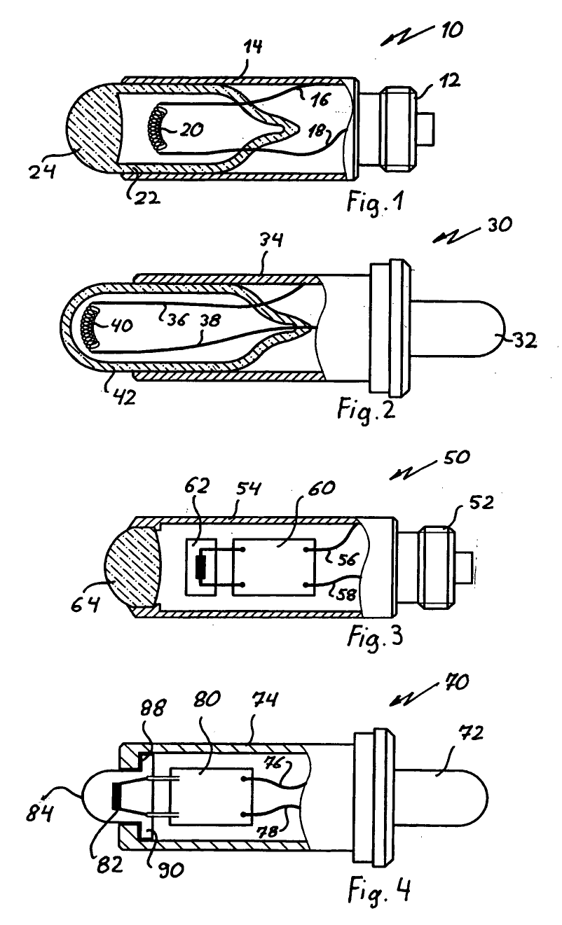

The known miniature electric light bulb 10 shown in FIG. 1 comprises a light-proof cylindrical lamp housing 14 at the right end of which, as shown in FIG. 1, a screwable lamp socket 12 is arranged. Two lead wires 16, 18 are connected to lamp socket 12 in a known manner. A coiled glow filament 20 arranged within lamp housing 14 is connected to the ends of lead wires 16 and 18, respectively. Filament 20 is arranged within a cone-shaped glass body 22. Glass body 22 extends beyond the right end of cylindrical housing 14, as shown in FIG. 1. The projecting end of glass body 22 is formed as lens cone 24.

The miniature electric light bulb 30 shown in FIG. 2 comprises a pluggable lamp socket 32 which is arranged at one end of a cylindrical lamp housing 34. Within lamp housing 34, a glass cone 42 is arranged in such a way that it projects beyond that end of lamp housing 34 which opposes lamp socket 32. Within glass cone 42, a coiled glow filament 40 is arranged which is connected to lead wires 36, 38, the lead wires 36, 38 being connected to lamp socket 32.

A first embodiment of a miniature electric lighting device 50 in accordance with the present invention is illustrated in FIG. 3; miniature electric lighting device 50, similar to miniature electric light bulb 10 of FIG. 1, comprises a screwable lamp socket 52 which is mounted to the right end of a cylindrical lamp housing 54, as shown in FIG. 3. Within lamp housing 54, adapter electronics 60 are arranged which are connected to lamp socket 52 through lead wires 56, 58. At the end of adapter electronics 60 remote from lamp socket 52, an LED (light emitting diode) 62 is arranged which is connected to adapter electronics 60. The end of lamp housing 54 remote from lamp socket 52 is sealed by a condenser lens 64, which condenser lens 64 divergently or convergently emits light emitted by LED 62.

The dimensions of lamp socket 52 and lamp housing 54 of miniature electric lighting device 50 in accordance with the present invention substantially correspond to the dimensions of lamp socket 12 and lamp housing 14 of the known miniature electric light bulb 10 shown in FIG. 1, so that in an illumination device known miniature electric light bulb 10 can be replaced by miniature electric lightning device 50 of the present invention.

The miniature electric lightning device 70 shown in FIG. 4 comprises a pluggable lamp socket 72 corresponding to lamp socket 32 of known miniature electric light bulb 30 of FIG. 2. As shown in FIG. 4, lamp socket 72 is arranged at the right end of a lightproof cylindrical lamp housing 74. Within lamp housing 74, adapter electronics 80 are arranged which are connected to lamp socket 72 through lead wires 76, 78. Connected to adapter electronics 80 is a LED 82. The LED 82 comprises a dome-shaped illuminant body 84, which on its end facing lamp socket 72 comprises a ring flange 90, which ring flange 90 abuts against a ring flange 88 of lamp housing 74, the ring flange 88 extending inwards. The dome-shaped body 84 of LED 82 extends through the left end of lamp housing 74, as shown in FIG. 4.

The dimensions of lamp housing 74 and lamp socket 72 of miniature electric light bulb 70 in accordance with the present invention substantially correspond to the dimensions of lamp housing 34 and lamp socket 32 of the known miniature electric light bulb 30 shown in FIG. 2, so that in an illumination device known miniature electric light bulb 30 can be replaced by miniature electric light bulb 70 of the present invention.

1. A lightning device comprising a component in which a light-emitting diode and adapter electronics are integrated, said component corresponding mechanically and electrically to an electric light bulb, said adapter electronics converting the voltage usually delivered to a conventional electric light bulb into a voltage required by said light-emitting diode.

2. The lightning device as claimed in claim 1, wherein the component comprises an optical system, preferably a positive lens.
